(19) United States
(12) Patent Application Publication
(10) Pub. No.: US 2014/0166442 A1
(43) Pub. Date: Jun. 19, 2014

(54) METHOD AND APPARATUS FOR UNLOADING A STOCKPILE

(71) Applicant: METSO PAPER, INC., Helsinki (FI)

(72) Inventor: Juha TOIVO, Eurajoki (FI)

(73) Assignee: METSO PAPER, INC., Helsinki (FI)

(21) Appl. No.: 14/104,396

(22) Filed: Dec. 12, 2013

(30) Foreign Application Priority Data
Dec. 13, 2012 (FI) 20126302

(51) Int. Cl. B65G 37/00

(52) U.S. Cl. CPC B65G 37/005
USPC 198/614

(57) ABSTRACT

The present invention is directed to an apparatus and a method for unloading a stockpile with an elongated unloading bridge, which is provided at its both ends with support wheels, the unloading bridge being horizontally movable at least in an essentially transverse direction with respect to a longitudinal direction of the unloading bridge. The unloading bridge includes at least one car movable along the unloading bridge, the car comprising at least one rake extending essentially transversally with respect to a longitudinal direction of the unloading bridge and inclined to a position between the horizontal and the vertical. Characteristically, the unloading bridge includes at least two adjacent conveyor screws below the unloading bridge and extending between the ends of the unloading bridge, each conveyor screw being provided with a thread opposite to that of an adjacent conveyor screw, and each conveyor screw being rotatable in a direction opposite to that of an adjacent conveyor screw. Further, the conveyor screws are positioned adjacently so that a free space is left between them, and the threads and rotating directions of the conveyor screws have been arranged so that the conveyor screws are adapted to forming a bank in the free space between them.

This application claims benefit of the filing date of F120126302, filed Dec. 13, 2012, the entire contents of which is incorporated herein by reference for all purposes.

### BACKGROUND

1. Field of the invention

The invention is directed to a method and apparatus for unloading material from a stockpile. Most preferably, the invention is directed to the unloading of chip and pellet storages, but it is also applicable for other granular materials of a corresponding type.

2. Description of Related Art

For the storage of chip piles, it is customary to use a method in which chips are gathered to an annular pile with a typical diameter of 80 to 150 m and a height of 20 to 30 m. In this kind of method new chips are introduced at one end of the pile, and stored chips are unloaded from the other end of the pile.

New chips are introduced from above the storage by a belt conveyor positioned in the conveyor bridge to the upper part of a tower-like construction at the centre of the annular pile. In the upper part of the tower, below the conveyor bridge, there is a boom fitted to the tower with a bearing and continuously turning around it. The chips are directed with the help of a funnel onto a belt conveyor located in the boom and forming a pile surrounding the tower. The pile is unloaded by means of a turnable unloading bridge circulating the tower continuously in the same direction and fitted from its one end with rotation bearings to the lower part of the tower and by means of an unloading conveyor constructed in the bridge. Additionally a rake-like grid reciprocating in the direction of the unloading bridge by a drive has been positioned in the unloading bridge, which grid is used for collapsing the pile onto the unloading conveyor. The unloading conveyor transfers the chips to the conveyor below the chip storage via a funnel located at the base of the tower. A known curved chip storage has been described for example in the publication EP 1587750, in which a screw conveyor has been used as the unloading member.

For the storage of granular materials a method in which the material is gathered as a straight stockpile having a typical width of 20 to 60 m and a height of 10 to 20 m is also used. There is no limit for the length of the stockpile. In the method, new material is introduced for example by means of a separate moving stacker that runs beside the pile and along it. The material can also be introduced by means of a belt conveyor moving in a bridge located above the pile and parallel to the pile. The material is unloaded at the unloading bridge reciprocating in the area of the pile and in the direction of the pile, the width of the body of the unloading bridge being larger than the pile. The body of the bridge is supported at its both ends to tracks parallel to the pile and running at the ground level outside the pile. The unloading member located in the lower part of the bridge is formed by a chain conveyor equipped with scrapers, which chain conveyor moves the material to the other end of the unloading bridge. The material is transported further from the unloading end by means of a belt conveyor. The material is unloaded from the upper side of the pile and collapsed to the reach of chain scrapers by means of a rake reciprocating in the body of the bridge as in with the method of the publication EP 1587750, in which there is a screw conveyor instead of a lug conveyor. The pile is unloaded from the running direction. As the unloading bridge is run to both directions, there is a rake collapsing the pile on both sides of the bridge.

The disadvantage of a scraper chain conveyor is its limited capacity. Also the maintenance costs are significant, and they increase as the desired unloading capacity is increased. By means of a screw conveyor a larger capacity, up to more than 2000 loose m³/h, is reached with lower construction costs. The use of a screw in a reciprocating bridge unloader is, however, problematic, as the screw requires a chute against which it transports material. In a turning bridge unloader, the chute is located on the opposite side of the screw with respect to the pile to be unloaded. In a stockpile, a fixed chute prevents the loader from running to the other direction. On the other hand, a removable chute is awkward, and in any case the transport capacity of the screw would be inferior when running to the other direction.

### SUMMARY

The apparatus according to the invention is characterized in that the unloading bridge comprises at least two adjacent conveyor screws below the unloading bridge and extending between the ends of the unloading bridge, each conveyor screw being provided with an opposite thread than an adjacent conveyor screw, and each conveyor screw being rotatable in an opposite direction than an adjacent conveyor screw. Further, conveyor screws have been positioned adjacently so that a free space is left between them, and the threads and rotating directions of the conveyor screws have been arranged so that the conveyor screws are adapted to forming a bank in the free space between them.

The method according to the invention is characterized in that a second conveyor screw in the running direction of the unloading bridge is rotated in a second direction that is opposite to the rotating direction of a first conveyor screw in the running direction. Additionally, the second conveyor screw is provided with a second thread that is opposite with respect to a first thread of the first conveyor screw, whereby when rotating the conveyor screws a bank of material to be unloaded is formed in the free space between them.

By means of the solutions according to the invention, a larger unloading capacity is reached than by means of an unloader provided with a scraper conveyor. Further, as no back chute is required in the solutions according to the invention, it is unnecessary to move the back chute of the conveyor screw when changing the unloading direction of the unloader. Further, as the unloader according to the invention is symmetrical with regard to its operation, its capacity is equally good in both running directions.

### BRIEF DESCRIPTION OF THE FIGURES

The invention and its details are described in more detail in the following by referring to the appended drawing in which:

FIG. 1 shows a straight-running unloader unloading a typical stockpile-type material pile by means of a lug conveyor;

FIG. 2 shows a straight-running unloader bridge unloading a pile by means of screws according to an embodiment of the invention; and

FIG. 3 shows the cross-section A-A in FIG. 2.

### DETAILED DESCRIPTION OF SPECIFIC EMBODIMENTS

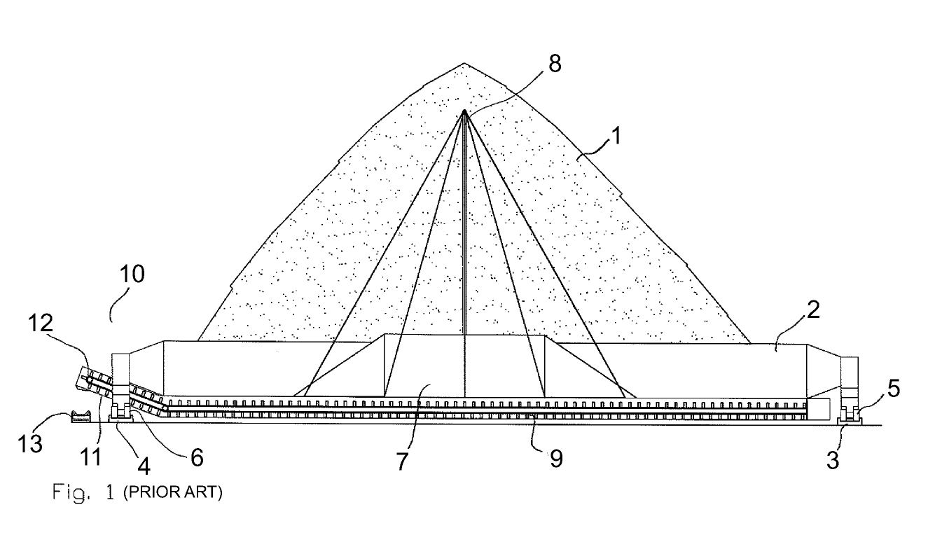

FIG. 1 shows a typical unloading bridge 2 unloading a stockpile-type pile 1. The pile 1 has been presented in a transverse direction with respect to its length. The device forming the pile is not shown. The unloading bridge 2 as shown is used particularly in the storage of various minerals. The unloading bridge 2 is supported on and reciprocates along running tracks 3,4 positioned in a longitudinal direction to the pile 1 on both sides of the pile outside it. The support is formed by multiple support wheels 5, 6 running along the tracks 3, 4. In order to move the unloading bridge 2, at least one wheel (not shown) provided with a drive has been arranged on its both sides. The unloading bridge 2 runs in a perpendicular direction against the pile 1. The unloading bridge 2 is provided with a rake car 7 moving along the bridge. Deviating from the figure, it is possible to have multiple rake cars 7. The car 7 or cars have rakes 8 on both sides of the bridge 2. The rake 8 collapses material from the pile 1 from the side of the running direction of the bridge. A continuous scraper conveyor 9 mounted to the bridge 2 and running below the bridge gathers the collapsed material and transports it to the unloading end of the bridge 10. At the unloading end, the lug conveyor 9 ascends along the chute 11 and transports the material overt the running track 4 with the chute 11. The material is dropped from a tail end 12 of the scraper conveyor onto a belt conveyor 13 below it, which belt conveyor transports the material to further processing. The scraper conveyor 9 is symmetrical with respect to its running direction, whereupon it functions in the same way irrespective of the running direction of the bridge 2.

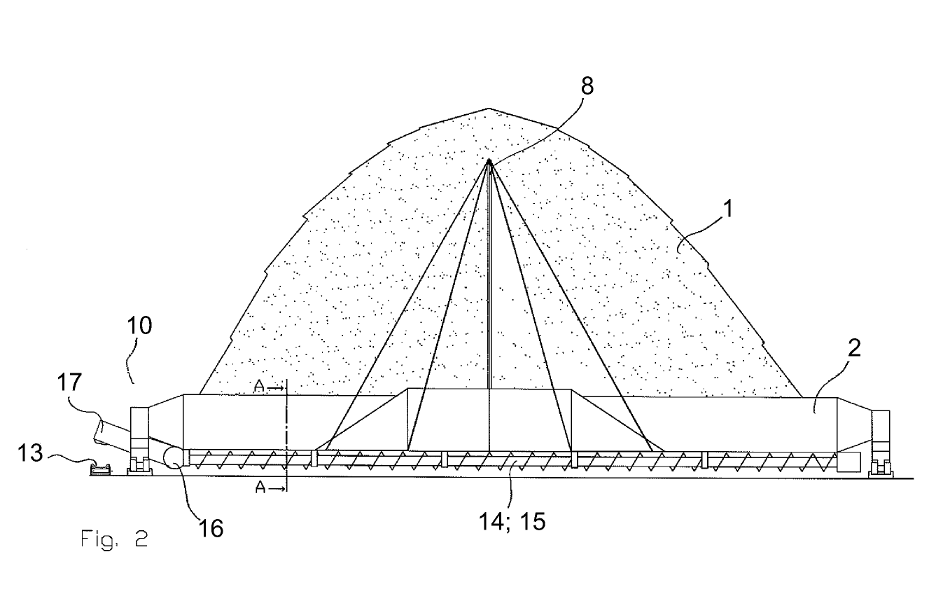

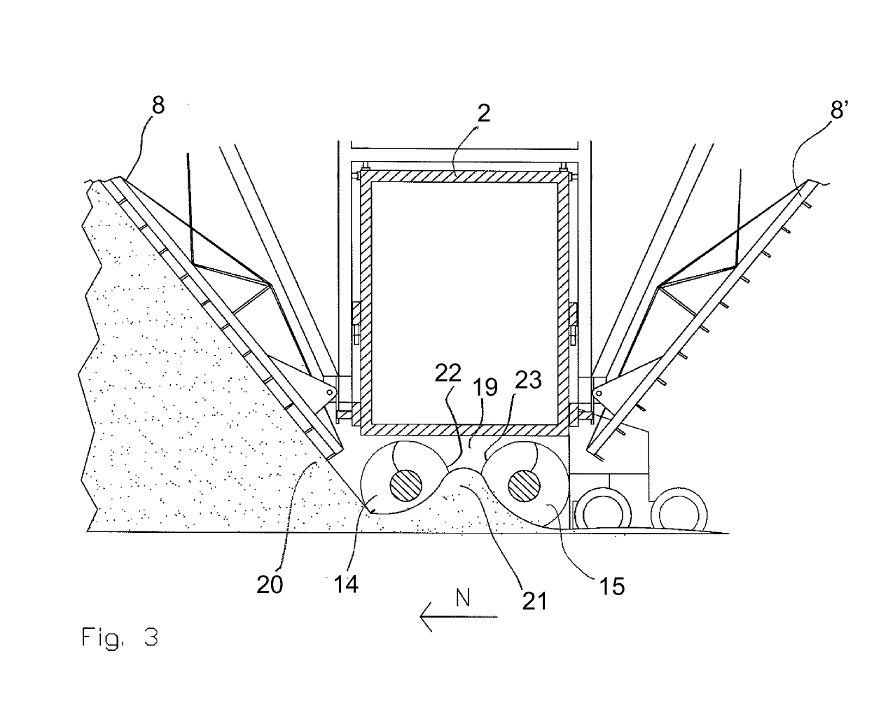

FIGS. 2 and 3 show a reciprocating unloading bridge 2 adapted to the unloading of a material storage 1 for chips or other granular material according to an embodiment of the invention. Deviating from the device of FIG. 1, the unloading bridge 2 is provided with two adjacent screws 14, 15, by means of which the chips collapsed by the rake 8 are moved to the unloading end 10 of the bridge. In the unloading end the chips are transported by one or more separate screws 16, 17 onto the belt conveyor 13. The screws 14, 15 shown in the cross-sectional view of FIG. 3 have opposite threads. There free space 19 between the screws. As the bridge runs in the direction of arrow N, the first screw 14 forms behind it a bank 21 of the chips 20 to be unloaded and transports most of the chips on the trailing side 22 of the screw 14 against the bank 21. The second screw 15 moves the chips with its leading edge 23 and unloads the bank 21 as the bridge 2 moves in the direction of the arrow N. The amount of chips removed upon the unloading of the bank 21 is so small that transport by means of the leading edge 23 of the screw 15 is possible.

An apparatus for unloading a stockpile according to an embodiment of the invention comprises an elongated unloading bridge 2. Preferably the unloading bridge 2 has a length larger than the width of the stockpile 1 to be unloaded. The unloading bridge 2 is provided with multiple support wheels 5, 6 at its both ends, by means of which wheels the unloading bridge 2 is movable at least in an essentially transverse direction with respect to its longitudinal direction. The apparatus further comprises at least one car 7 movable along the unloading bridge 2 in its longitudinal direction. The car 7 is provided with at least one rake 8 that extends essentially transversally with respect to the longitudinal direction of the unloading bridge 2 and has been inclined to a position between the horizontal and the vertical. Preferably the rake 8 has been set to inclination that is specific to the material to be collapsed with regard to the pile 1. The apparatus further includes at least two conveyor screws 14, 15 below the unloading bridge 2. The conveyor screws 14, 15 extend between the ends of the unloading bridge 2, having a length that is preferably at least as great as the width of the stockpile 1 and being parallel to the unloading bridge 2. The conveyor screws 14, 15 have been provided with opposite threads with regard to each other, and they are rotatable to opposite directions, whereby each screw is able to transport material to the same direction, towards the unloading end 10. Further, the conveyor screws 14, 15 have been positioned with regard to each other so that a free space 19 is left between them. The threads and rotation directions of the conveyor screws 14, 15 must be arranged so that when rotated, the conveyor screws 14, 15 form a bank 21 of the material 20 to be unloaded in the free space 19 left between them. In other words, the conveyor screws must be mutually inwards pushing. The bank is formed as the conveyor screws 14, 15 move the material to be unloaded towards the unloading end 10 of the unloading bridge. This enables the screws (14, 15) to convey material from said stockpile against said bank 21. As the conveyor screws 14, 15 move the material to be unloaded against the bank 21, said bank 21 acts as a chute for the screws (14, 15).

In an apparatus according to another embodiment of the invention, at least one car 7 is provided with two opposite rakes 8 that extend transversally with respect to the longitudinal direction of the unloading bridge 2, both rakes 8 being inclined to a position between the horizontal and the vertical. This enables running the unloader to two directions. Also other car/rake configurations are possible. Each car 7 may be provided, for example, with one or more adjacent and/or opposite rakes 8. An apparatus according to the invention may also comprise multiple cars 7.

In an arrangement according to an embodiment of the invention, essentially parallel tracks 3, 4 run on the both sides of an elongated stockpile 1, along the longitudinal direction of said stockpile 1. An apparatus according to any of the embodiments of the invention described above is set on the tracks 3, 4 in order to be moved. Preferably, the support wheels 5, 6 located at the end of the unloading bridge have been adapted to co-operate with the tracks. Further, at least one rake 8 has been tilted, with respect to the longitudinal direction of the stockpile 1, against a transverse end of the stockpile. Additionally, the end 10 of the conveyor screws 14, 15 of the unloading bridge 2 on the side of the running direction, i.e. the unloading end 10, is provided with discharge conveyors 16, 17, by which the material unloaded from the stockpile can be removed from between the tracks 3, 4 in order to be further processed.

In a method according to an embodiment of the invention, at least one car 7 of the unloading bridge 2 and at least one rake 8 therein is moved in the longitudinal direction of the unloading bridge as said at least one rake 8 is tilted against a transverse end with respect to the longitudinal direction of the stockpile 1. Moving the rake 8 against the end surface of the stockpile 1 causes the material in the stockpile 1 to collapse to the bottom of the end of the stockpile 1. By means of the rake 8 the material residing in the upper parts of the stockpile 1 is thus made to fall to a lower level, from where it can be further transported by means of the unloader. The unloading bridge 2 is moved transversally with respect to its longitudinal direction towards the material 20 collapsed to the bottom of the end of the stockpile 1, so that the screws 14, 15 below the unloading bridge 2 come into contact with said material. Further, in the running direction of the unloading bridge 2, a first conveyor screw 14, which is provided with a first thread, is rotated in a first direction. Correspondingly, in the running direction of the unloading bridge, a second conveyor screw 15, which is provided with a second thread opposite with respect to the first thread, is rotated in a second direction. The threads and rotating directions of the conveyor screws 14, 15 must be arranged so that they form a bank 21 of the material 20 to be unloaded in a free space 19 between them. This enables the screws 14, 15 to convey material from said stockpile against said bank 21. Preferably, the above mentioned functions are performed essentially simultaneously, whereby the unloading of the stockpile is accomplished as a continuous process.

During the unloading operation, while rotating, the first conveyor screw 14 with respect to the running direction of the unloading bridge 2 forms behind itself a bank 21 of the material 20 to be unloaded. The formed bank 21 acts as a back chute for the conveyor screw 14, against which back chute the trailing edge 22 of the conveyor screw 14 moves material 20 to be unloaded towards the unloading end 10 of the unloading bridge 2. The trailing conveyor screw 15 with respect to the running direction of the unloading bridge 2 tries to push the material to be unloaded ahead it, thus contributing to the holding together of the bank 21. The leading edge 23 of the trailing conveyor screw 15 unloads material residing in the bank 21 as the unloading bridge 2 advances.

As the bridge 2 runs in an opposite direction (not in the direction N), the functional roles of the screws 14, 15 are interchanged. However, they still transport the chips to the same direction, towards the unloading end 10 of the bridge 2. Therefore, the bank 21 always operates as the back chute of the leading screw, so that a separate structural chute that is movable between the sides of the unloading bridge 2 is not required when changing the running direction of the bridge.

1. Apparatus for unloading a stockpile, comprising:
an elongated unloading bridge provided at its both ends with support wheels, the unloading bridge being horizontally movable at least in an essentially transverse direction with respect to a longitudinal direction of the unloading bridge;
at least one car movable along the unloading bridge, the car comprising at least one rake extending essentially transversally with respect to a longitudinal direction of the unloading bridge and inclined to a position between the horizontal and the vertical;
wherein the unloading bridge comprises at least two adjacent conveyor screws residing below the unloading bridge and extending between the ends of the unloading bridge, each conveyor screw being provided with a thread opposite to that of an adjacent conveyor screw, and each conveyor screw being rotatable in a direction opposite to that of an adjacent conveyor screw, the conveyor screws being further positioned adjacently so that a free space is formed between them, and the threads and rotating directions of the conveyor screws being arranged so that the conveyor screws are adapted to forming a bank in the free space between them for enabling the screws to convey material from said stockpile against said bank.

2. Apparatus according to claim 1, wherein the at least one car movable along the unloading bridge comprises two opposite rakes extending in an essentially transverse direction with respect to a longitudinal direction of the unloading bridge in opposite directions, both rakes being inclined to a position between the horizontal and the vertical.

3. Arrangement for unloading a stockpile, comprising:
essentially parallel tracks running on both sides of an elongated stockpile in a longitudinal direction of said stockpile;
an apparatus according to claim 1 positioned on said tracks to be movable along them,
in which arrangement said at least one rake is inclined against a transverse end of the stockpile with respect to the longitudinal direction of the stockpile, and a discharge conveyor has been arranged at the conveying direction side end of the conveyor screws in order to remove material unloaded from the stockpile from between the tracks and to further processing.

4. Method for unloading a stockpile, comprising the following steps:
moving a car and a rake of an unloading bridge in a longitudinal direction of the unloading bridge, the rake being tilted against a transverse end with respect to a longitudinal direction of the stockpile, for collapsing material residing in the stockpile to the bottom of said end;
moving the unloading bridge transversally with respect to its longitudinal direction towards the material collapsed to the bottom of said end;
in the running direction of the unloading bridge, rotating a first conveyor screw is in a first direction, said first conveyor screw being provided with a first thread,
wherein in the running direction of the unloading bridge, a second conveyor screw is rotated in a second direction, which is opposite to said first direction, said second conveyor screw being provided with a second thread, which is opposite to said first thread, so that a bank is formed in a free space between the conveyor screws for enabling the screws to convey material from said stockpile against said bank.

5. Method according to claim 4, in which method said operations are performed essentially simultaneously.
